(19) United States
(12) Patent Application Publication
(10) Pub. No.: US 2018/0281803 A1
(43) Pub. Date: Oct. 4, 2018

(54) VEHICLE CONTROL DEVICE

(71) Applicant: HONDA MOTOR CO., LTD., Tokyo (JP)

(72) Inventors: Takuyuki Mukai, Wako-shi (JP); Jun Tanaka, Wako-shi (JP); Shigehiro Honda, Wako-shi (JP); Jun Ibuka, Wako-shi (JP)

(21) Appl. No.: 15/936,642

(22) Filed: Mar. 27, 2018

(30) Foreign Application Priority Data
Mar. 31, 2017 (JP) 2017-071106

(51) Int. Cl. B60W 30/18; G05D 1/00; G05D 1/02; B60W 40/04; B60W 50/14; B60W 50/08

(52) U.S. Cl. CPC B60W 30/18154; G05D 1/0061; G05D 1/0214; G05D 1/0276; B60W 2720/10; B60W 50/14; B60W 50/082; G05D 2201/0213; B60W 2550/22; B60W 40/04

(57) ABSTRACT

A vehicle control device is equipped with an intersection detection unit configured to detect an intersection that is on a planned travel route of a host vehicle, and in which it is intended to turn to the right or left from a first travel lane across a first oncoming lane, and a driving control unit configured to carry out a travel control automatically, so as to avoid a situation in which the host vehicle is left remaining within the detected intersection.

### CROSS-REFERENCE TO RELATED APPLICATION

This application is based upon and claims the benefit of priority from Japanese Patent Application No. 2017-071106 filed on Mar. 31, 2017, the contents of which are incorporated herein by reference.

### BACKGROUND OF THE INVENTION

### Field of the Invention

The present invention relates to a vehicle control device which carries out a travel control for a host vehicle at least partially automatically.

### Description of the Related Art

Conventionally, a vehicle control device has been known in which a travel control for a user's own vehicle (also referred to herein as a “host vehicle”) is performed at least partially automatically. For example, various driving assist technologies have been developed for enabling smooth traveling of the host vehicle in the vicinity of an intersection, while taking into consideration the relationship of the host vehicle with other vehicles.

In Japanese Laid-Open Patent Publication No. 2015-147525 (refer to paragraph [0039], etc.), a vehicle control device has been proposed in which, in the case that an arrival distance to an intersection is less than or equal to a threshold value, a target distance in an inter-vehicle distance control is set to a value which is greater than a predetermined value (a distance from an entry position to an exit position of the intersection). In accordance with this feature, it is generally described that, since the host vehicle cannot enter into the intersection at least during a period in which a preceding vehicle is passing through the intersection, the traffic flow of the intersecting lane is not obstructed.

### SUMMARY OF THE INVENTION

Incidentally, in the case that the host vehicle turns to the right or left (in the case of Japan, turns to the right) at the intersection, if traffic conditions exist in which there is an ample time margin until a traffic signal changes to a red signal, or alternatively, if traffic conditions exist in which traffic flow in the oncoming lane is small, then it is possible for the host vehicle to make a right or left turn without being left remaining within the intersection. Stated otherwise, depending on the traffic conditions, it is possible for the host vehicle to make a right or left turn while continuing with automated driving.

However, when the method proposed in Japanese Laid-Open Patent Publication No. 2015-147525 (paragraph [0039], etc.) is applied without modification to automated driving, then regardless of local or temporal changes in traffic conditions, the vehicle is caused to stop just before the intersection without attempting to enter into the intersection. As a result, the time required to pass through the intersection is lengthened, and merchantability of the vehicle also tends to be impaired from the standpoint of driving convenience.

The present invention has been devised in order to solve the aforementioned problems, and has the object of providing a vehicle control device which is capable of improving driving convenience in the case of making a right or left turn at an intersection.

A vehicle control device according to the present invention is configured to control traveling of a host vehicle at least partially automatically, and includes an intersection detection unit configured to detect an intersection that is on a planned travel route of the host vehicle, and in which it is intended to turn to the right or left from a first travel lane across a first oncoming lane opposed to the first travel lane, and a driving control unit configured to perform a travel control automatically, so as to avoid a situation in which the host vehicle is left remaining within the intersection that is detected by the intersection detection unit.

Since such a configuration is provided, under the automated travel control, the host vehicle is capable of turning to the right or left at the intersection as quickly as possible, while taking into consideration situations in which the host vehicle may be left remaining within the intersection through which the vehicle intends to pass. Consequently, driving convenience in the case of turning to the right or left at the intersection is enhanced.

The above-described vehicle control device may further include a possibility determining unit configured to make a determination concerning a possibility for the host vehicle to be left remaining within the intersection, wherein, in the case it is determined by the possibility determining unit that the possibility is relatively high, the driving control unit may perform a travel control that differs from a case in which it is determined that the possibility is relatively low. In accordance with this feature, suitable driving is performed corresponding to the possibility of being left remaining within the intersection.

Further, the above-described vehicle control device may further include an information acquisition unit configured to acquire traffic signal information in relation to an illumination time of a traffic signal installed at the intersection, wherein, using the traffic signal information acquired by the information acquisition unit, the possibility determining unit may make the determination concerning the possibility by evaluating a time concerned with right or left turning of the host vehicle. By acquiring the traffic signal information in relation to the illumination time of the traffic signal, it becomes possible to quantitatively evaluate the possible remaining time after entering into the intersection, and by such an amount, the accuracy in determining the possibility can be improved.

Further, in the above-described vehicle control device, the information acquisition unit may further acquire traffic flow information in relation to a flow of traffic in the first oncoming lane, wherein, further using the traffic flow information acquired by the information acquisition unit, the possibility determining unit may make the determination concerning the possibility by evaluating a time concerned with right or left turning of the host vehicle. By further acquiring the traffic flow information in relation to the flow of traffic in the first oncoming lane, it becomes possible to quantitatively evaluate the time required when crossing over the first oncoming lane, and by such an amount, the accuracy in determining the possibility can be improved.

Further, in the above-described vehicle control device, the possibility determining unit may make the determination concerning the possibility during a period in which the host vehicle has not yet reached the intersection, and in the case it is determined that the possibility is relatively low, the driving control unit may perform a travel control to cause the host vehicle to enter into the intersection, whereas in the case it is determined that the possibility is relatively high, the driving control unit may perform a travel control to cause the host vehicle to stop in front of the intersection.

Further, in the above-described vehicle control device, in the case it is determined that the possibility is relatively high, the driving control unit may perform a request control to issue a request with respect to a driver of the host vehicle to take over responsibility for manual driving, while the host vehicle is being decelerated, or is in a state in which the host vehicle is stopped. In accordance with this feature, prior to making a right or left turn at the intersection, the responsibility for driving can smoothly be handed over to the driver.

Further, in the case that the host vehicle makes a right or left turn at the intersection by moving from the first travel lane into a second travel lane that intersects with the first travel lane, while crossing over the first oncoming lane, the possibility determining unit may make the determination concerning the possibility during a period in which the host vehicle exists in an intersection region of the first travel lane with a second oncoming lane opposed to the second travel lane.

Further, in the above-described vehicle control device, in the case it is determined that the possibility is relatively low, the driving control unit may perform a travel control to continue to stop the host vehicle, whereas in the case it is determined that the possibility is relatively high, the driving control unit may perform a travel control to cause the host vehicle to move to within an intersection region of the first travel lane with the second travel lane. By causing the host vehicle to move into the second travel lane, the crossing distance of the first oncoming lane becomes shorter, and by such an amount, the time required for making the right or left turn is shortened. Also, by causing the host vehicle to evacuate from the second oncoming lane in advance, the flow of traffic from the second oncoming lane immediately after a change in the currently displayed state of the traffic signal is not obstructed.

In accordance with the vehicle control device of the present invention, it is possible to improve driving convenience in the case of making a left or right turn at an intersection.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing the configuration of a vehicle control device according to an embodiment of the present invention;

FIG. 2 is a flowchart for describing operations of the vehicle control device shown in FIG. 1;

FIG. 3 is a diagram showing an intersection detected in step S2 of FIG. 2;

FIG. 4 is a diagram for explaining an evaluation method (step S5 of FIG. 2) of the possibility that the host vehicle will be left remaining within the intersection;

FIG. 5 is a diagram showing a state in which the host vehicle enters into the intersection;

FIG. 6 is a diagram showing a state in which the host vehicle stops before entering into the intersection;

FIG. 7 is a detailed flowchart in relation to a right or left turn control (step S7 of FIG. 2) of the host vehicle;

FIG. 8 is a diagram showing a first state in which the host vehicle stops within the intersection; and

FIG. 9 is a diagram showing a second state in which the host vehicle stops within the intersection.

### DESCRIPTION OF THE PREFERRED EMBODIMENTS

Preferred embodiments of a vehicle control device according to the present invention will be presented and described in detail below with reference to the accompanying drawings.

### [Configuration of Vehicle Control Device 10]

### <Overall Configuration>

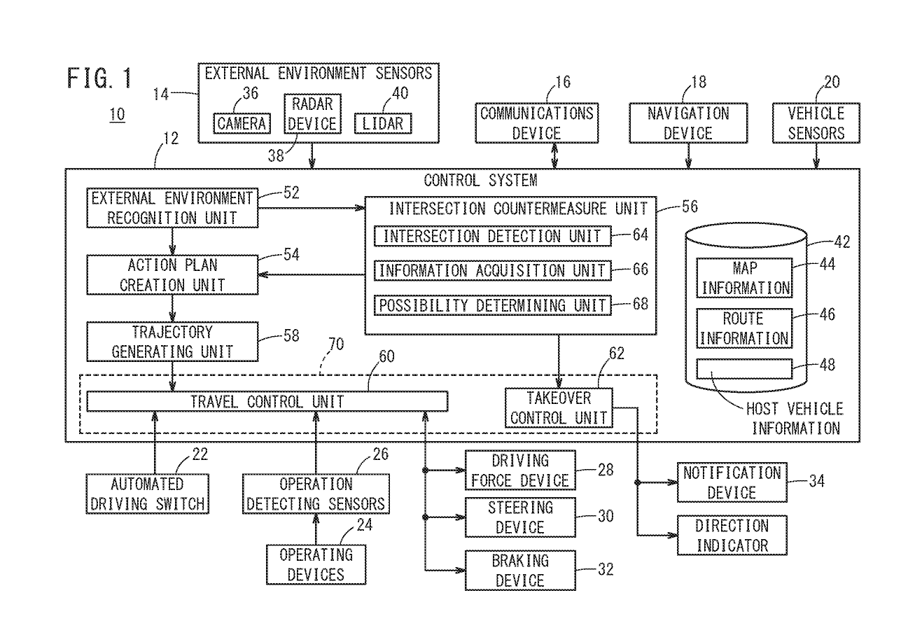

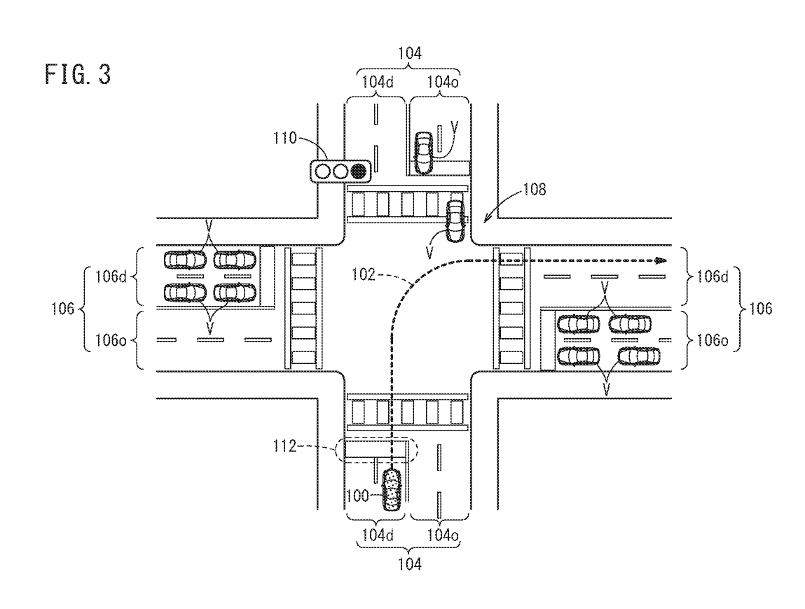

FIG. 1 is a block diagram showing the configuration of a vehicle control device 10 according to an embodiment of the present invention. The vehicle control device 10 is incorporated in a vehicle (the host vehicle 100 shown in FIG. 3, etc.), and performs a travel control for the vehicle by way of automated or manual driving. The term “automated driving” implies a concept that includes not only “fully automated driving” in which the travel control for the vehicle is performed entirely automatically, but also “partial automated driving” in which the travel control is partially performed automatically.

The vehicle control device 10 is basically made up from an input system device group, a control system 12, and an output system device group. The respective devices of the input system device group and the output system device group are connected via communication lines to the control system 12.

The input system device group includes external environment sensors 14, a communications device 16, a navigation device 18, vehicle sensors 20, an automated driving switch 22, and operation detecting sensors 26 connected to operating devices 24.

The output system device group includes a driving force device 28 for driving vehicle wheels (not shown), a steering device 30 for steering the vehicle wheels, a braking device 32 for braking the vehicle wheels, and a notification device 34 for notifying the driver through visual sensation.

### <Specific Configuration of Input Device Group>

The external environment sensors 14 acquire information (hereinafter referred to as external environmental information) indicative of the state of the external environment around the vehicle, and output the acquired external environmental information to the control system 12. More specifically, the external environment sensors 14 are configured to include a plurality of cameras 36, a plurality of radar devices 38, and a plurality of LIDAR devices 40 (Light Detection and Ranging; Laser Imaging Detection and Ranging).

The communications device 16 is configured to be capable of communicating with external devices including roadside devices, other vehicles, and a server, and transmits and receives, for example, information related to transportation facilities, information related to other vehicles, probe information, or latest map information 44. The map information 44 is stored in a predetermined memory area of a storage device 42, or alternatively in the navigation device 18.

The navigation device 18 is constituted to include a satellite positioning device, which is capable of detecting a current position of the vehicle, and a user interface (for example, a touch-panel display, a speaker, and a microphone). Based on the current position of the vehicle or a position designated by the user, the navigation device 18 calculates a route to a designated destination point, and outputs the route to the control system 12. The route calculated by the navigation device 18 is stored as route information 46 in a predetermined memory area of the storage device 42.

The vehicle sensors 20 output to the control system 12 detection signals from respective sensors, including a speed sensor for detecting the travel speed (vehicle velocity), an acceleration sensor for detecting an acceleration, a lateral G sensor for detecting a lateral G force, a yaw rate sensor for detecting an angular velocity about a vertical axis, an orientation sensor for detecting an orientation, and a gradient sensor for detecting a gradient of the vehicle. The detection signals are stored as host vehicle information 48 in a predetermined memory area of the storage device 42.

The automated driving switch 22 is constituted, for example, from a push button type hardware switch, or a software switch utilizing the navigation device 18. The automated driving switch 22 is configured to be capable of switching between a plurality of driving modes, by manual operation thereof by a user including the driver.

The operating devices 24 include an accelerator pedal, a steering wheel, a brake pedal, a shift lever, and a direction indication (turn signal) lever. The operation detecting sensors 26, which detect the presence or absence or the operated amounts of operations made by the driver, as well as operated positions, are attached to the operating devices 24.

The operation detecting sensors 26 output to a travel control unit 60 as detection results an amount by which the accelerator pedal is depressed (degree of accelerator opening), an amount (steering amount) by which the steering wheel is operated, an amount by which the brake pedal is depressed, a shift position, and a right or left turn direction, etc.

### <Specific Configuration of Output System Device Group>

The driving force device 28 is constituted from a driving force ECU (Electronic Control Unit), and a drive source including an engine and/or a driving motor. The driving force device 28 generates a travel driving force (torque) for the vehicle in accordance with travel control values input thereto from the travel control unit 60, and transmits the travel driving force to the vehicle wheels directly or through a transmission.

The steering device 30 is constituted from an EPS (electric power steering system) ECU, and an EPS device. The steering device 30 changes the orientation of the wheels (steered wheels) in accordance with travel control values input thereto from the travel control unit 60.

The braking device 32, for example, is an electric servo brake used in combination with a hydraulic brake, and is made up from a brake ECU and a brake actuator. The braking device 32 brakes the vehicle wheels in accordance with travel control values input thereto from the travel control unit 60.

The notification device 34 is made up from a notification ECU, a display device, and an audio device. The notification device 34 performs a notifying operation (including a later-described TOR) in relation to automated driving or manual driving, in accordance with a notification command output from the control system 12 (and more specifically, a takeover control unit 62 thereof).

### <Driving Modes>

An “automated driving mode” and a “manual driving mode” (non-automated driving mode) are switched sequentially each time that the automated driving switch 22 is pressed. Instead of this feature, in order to provide confirmation of a driver's intention, it is possible to provide settings in which, for example, switching from the manual driving mode to the automated driving mode is effected by pressing twice, and switching from the automated driving mode to the manual driving mode is effected by pressing once.

The automated driving mode is a driving mode in which the vehicle travels under the control of the control system 12 while the driver does not operate the operating devices 24 (specifically, the accelerator pedal, the steering wheel, and the brake pedal). Stated otherwise, in the automated driving mode, the control system 12 controls a portion or all of the driving force device 28, the steering device 30, and the braking device 32 in accordance with sequentially created action plans.

When the driver performs a predetermined operation using the operating devices 24 during implementation of the automated driving mode, the automated driving mode is canceled automatically, together with switching to a driving mode (which may include the manual driving mode) in which the degree of automated driving is relatively low. Hereinafter, an operation in which the driver operates the automated driving switch 22 or any one of the operating devices 24 in order to transition from automated driving to manual driving will also be referred to as a “takeover operation”.

### <Configuration of Control System 12>

The control system 12 is constituted by one or a plurality of ECUs, and comprises various function realizing units in addition to the aforementioned storage device 42. According to the present embodiment, the function realizing units are software-based functional units, in which the functions thereof are realized by one or a plurality of CPUs (central processing units) executing programs that are stored in the non-transitory storage device 42. Alternatively, the function realizing units may be hardware-based functional units made up from integrated circuits such as field-programmable gate arrays (FPGA) or the like.

In addition to the storage device 42 and the travel control unit 60, the control system 12 is configured to include an external environment recognition unit 52, an action plan creation unit 54, an intersection countermeasure unit 56, a trajectory generating unit 58, and the takeover control unit 62.

Using various information input thereto from the input system device group (for example, external environmental information from the external environment sensors 14), the external environment recognition unit 52 recognizes lane markings (white lines) on both sides of the vehicle, and generates “static” external environment recognition information, including location information of stop lines and traffic signals, or travel enabled regions in which traveling is possible. Further, using the various information input thereto, the external environment recognition unit 52 generates “dynamic” external environment recognition information, including information concerning obstacles such as parked or stopped vehicles, traffic participants such as people and other vehicles, and the colors of traffic signals.

On the basis of recognition results from the external environment recognition unit 52, the action plan creation unit 54 creates action plans (a time series of events) for each of respective travel segments, and updates the action plans as needed. As types of events, for example, there may be cited events in relation to deceleration, acceleration, branching, merging, intersections, lane keeping, lane changing, and passing other vehicles. In this instance, “deceleration” and “acceleration” are events in which the vehicle is made to decelerate or accelerate. “Branching” and “merging” and “intersections” are events in which the vehicle is made to travel smoothly at a branching point, a merging point, or an intersection. “Lane changing” is an event in which the travel lane of the vehicle is made to change (i.e., a change in course is made). “Passing” is an event in which the vehicle is made to overtake a preceding vehicle.

Further, “lane keeping” is an event in which the vehicle is made to travel without departing from the travel lane, and is subdivided based on a combination of travel modes. More specifically, as such travel modes, there may be included constant speed traveling, follow-on traveling, traveling while decelerating, traveling through a curve, or traveling to avoid obstacles.

The intersection countermeasure unit 56 performs various measures (referred to herein as signal processing) in relation to passage through the intersections (going straight ahead or turning to the right or left) using various information from the external environment recognition unit 52 or the action plan creation unit 54. In addition, the intersection countermeasure unit 56 outputs command signals to the action plan creation unit 54 or the takeover control unit 62 in order to carry out the aforementioned countermeasures. More specifically, the intersection countermeasure unit 56 functions as an intersection detection unit 64, an information acquisition unit 66, and a possibility determining unit 68.

Using the map information 44, the route information 46, and the host vehicle information 48, which are read in from the storage device 42, the trajectory generating unit 58 generates a travel trajectory (a time series of target behaviors) in accordance with the action plan created by the action plan creation unit 54. More specifically, the travel trajectory is a time series data set, in which the data units thereof are defined by a position, a posture angle, a velocity, an acceleration, a curvature, a yaw rate, and a steering angle.

The travel control unit 60 determines respective travel control values in order to control traveling of the vehicle, in accordance with the travel trajectory (time series of target behaviors) generated by the trajectory generating unit 58. In addition, the travel control unit 60 outputs the obtained travel control values, respectively, to the driving force device 28, the steering device 30, and the braking device 32.

The takeover control unit 62 drives and controls the notification device 34 in accordance with commands from the intersection countermeasure unit 56. Hereinafter, the travel control unit 60 and the takeover control unit 62 may be referred to collectively as a “driving control unit 70” in certain cases.

### [Operations of Vehicle Control Device 10]

### <Overall Process Flow>

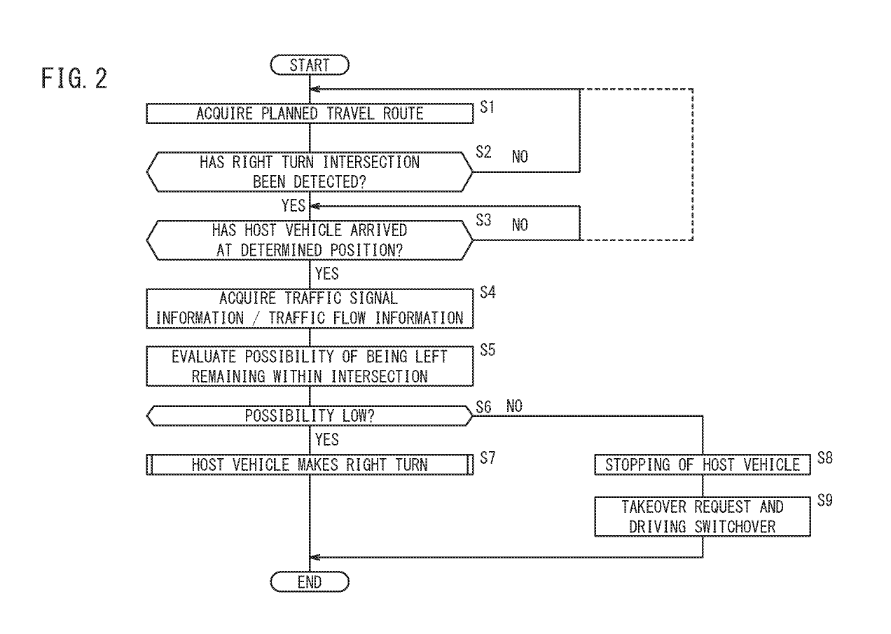

The vehicle control device 10 according to the present embodiment is configured basically in the manner described above. Next, operations of the vehicle control device 10 at a time of turning right or left at an intersection 108 (FIG. 3) will be described primarily with reference to the flowchart of FIG. 2. In this instance, a case will be assumed in which the host vehicle 100, which is equipped with the vehicle control device 10, travels by way of automated driving.

In step S1 of FIG. 2, using recent route information 46 stored in the storage device 42, or the “static” external environment recognition information generated by the external environment recognition unit 52, the intersection countermeasure unit 56 acquires a route (hereinafter referred to as a “planned travel route 102”) on which the host vehicle 100 intends to travel.

In step S2, the intersection detection unit 64 detects a right turn intersection by referring to the planned travel route 102 acquired in step S1 and the action plan (right or left turning event) created by the action plan creation unit 54. More specifically, the “right turn intersection” is an intersection [1] which is located on the planned travel route 102, [2] where a plurality of lanes intersect one another, [3] where the host vehicle 100 plans to make a right turn, and [4] lying within a predetermined distance range from the current position of the host vehicle 100 (or that the host vehicle 100 can reach within a predetermined time range).

As shown in FIG. 3, the host vehicle 100 travels along the planned travel route 102 indicated by the dashed line arrow, and the host vehicle 100 attempts to pass through a point (i.e., the intersection 108) where a first road 104 and a second road 106 intersect. The first road 104, which is made up from four lanes, is constituted from a first travel lane 104d (two lanes) in which the host vehicle 100 is scheduled to travel, and a first oncoming lane 104o (two lanes) opposed to the first travel lane 104d. The second road 106, which is made up from four lanes, is constituted from a second travel lane 106d (two lanes) in which the host vehicle 100 is scheduled to travel, and a second oncoming lane 106o (two lanes) opposed to the second travel lane 106d.

A traffic signal 110 which indicates whether or not vehicles can proceed is installed in the vicinity of a corner of the intersection 108. To facilitate description, only the traffic signal 110 corresponding to the first travel lane 104d is illustrated, although in actuality, traffic signals corresponding to the first oncoming lane 104o, the second travel lane 106d, and the second oncoming lane 106o are also installed respectively at the intersection.

The traffic signal 110 expresses three possible current states, namely, a progress allowable state, a progress prohibited state, and a transient state, by being illuminated with a blue color (actually, a green color), a red color, and a yellow color. In this instance, the “progress allowable state” is a state permitting progress of vehicles, and the “progress prohibited state” is a state prohibiting progress of vehicles through the traffic signal. Further, the “transient state” is an intermediate state in which a transition takes place from the “progress allowable state” to the “progress prohibited state”.

In the example illustrated in the drawing, the traffic signal 110 is illuminated with the color “blue” indicative of the progress allowable state. In this case, vehicles (the host vehicle 100 and another vehicle V) on the first road 104 are in the “progress allowable state”, whereas the vehicles (other vehicles V) on the second road 106 are in the “progress prohibited state”.

In the present drawing, a road is illustrated for a country where it has been decided that automobiles are to travel “on the left”. More specifically, when the host vehicle 100 makes a right turn at the intersection 108, it is necessary for the host vehicle 100 to move sequentially from the first travel lane 104d, across the first oncoming lane 104o, and into the second travel lane 106d that intersects with the first travel lane 104d. Conversely, in regions where it has been decided that automobiles are to travel “on the right”, such a situation corresponds to “when making a left turn at the intersection”.

In the case that a right turn intersection (that is, the specified intersection 108) is not detected (step S2: NO), the process returns to step S1, and steps S1 and S2 are sequentially repeated thereafter. On the other hand, if the specified intersection 108 is detected (step S2: YES), the process proceeds to step S3.

In step S3, the intersection countermeasure unit 56 determines whether or not the host vehicle 100 has reached a position (hereinafter referred to as a “determined position”) on a side in front of the intersection 108 by a predetermined travel distance (i.e., the predetermined travel distance short of the intersection 108). In the case that the host vehicle 100 has not yet reached the determined position (step S3: NO, solid line), the process remains at step S3 until the determined position is reached.

Moreover, if the planned travel route 102 is changed before the host vehicle 100 reaches the determined position, since there is a possibility that the host vehicle 100 may not reach the determined position (step S3: NO, dashed line), in this case, the process may also be returned to step S1. On the other hand, if it is determined that the host vehicle 100 has reached the determined position (step S3: YES), the process proceeds to step S4.

In step S4, the information acquisition unit 66 acquires traffic signal information and/or traffic flow information from a VICS (Vehicle Information and Communication System, registered trademark) through the communications device 16. In this instance, the “traffic signal information” is information concerning an illumination time of the traffic signal 110, and for example, a TSPS (Traffic Signal Prediction System) may be used therefor. Further, the “traffic flow information” is information concerning the flow of traffic in the first oncoming lane 104o, and for example, recent traffic congestion information, traffic disturbance information, or traffic regulation information may be used therefor.

In step S5, using the various information acquired in step S4, the possibility determining unit 68 evaluates the possibility of the host vehicle 100 being left remaining within the intersection 108. More specifically, using the traffic signal information and/or the traffic flow information, the possibility determining unit 68 evaluates the time concerned with right turning of the host vehicle 100. It should be noted that such a computational process is performed during a period in which the host vehicle 100 has not yet reached the intersection 108.

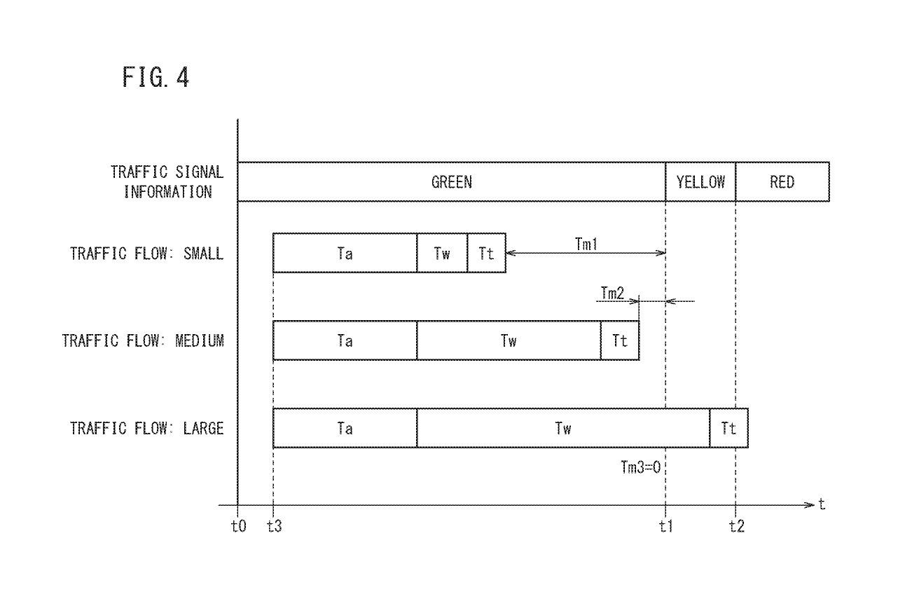

As shown in FIG. 4, the traffic signal information is table data in which the respective lamp colors are associated with illumination starting points (time t). In the time zone of t0≤t<t1, the traffic signal 110 displays the progress allowable state by being turned to “green”. In the time zone of t1≤t<t2, the traffic signal 110 displays the transient state by being turned to “yellow”. In the time zone of t≥t2, the traffic signal 110 displays the progress prohibited state by being turned to “red”. Moreover, time t3 (t0<t3<t1) is a point in time which the possibility determining unit 68 uses as a determination criterion.

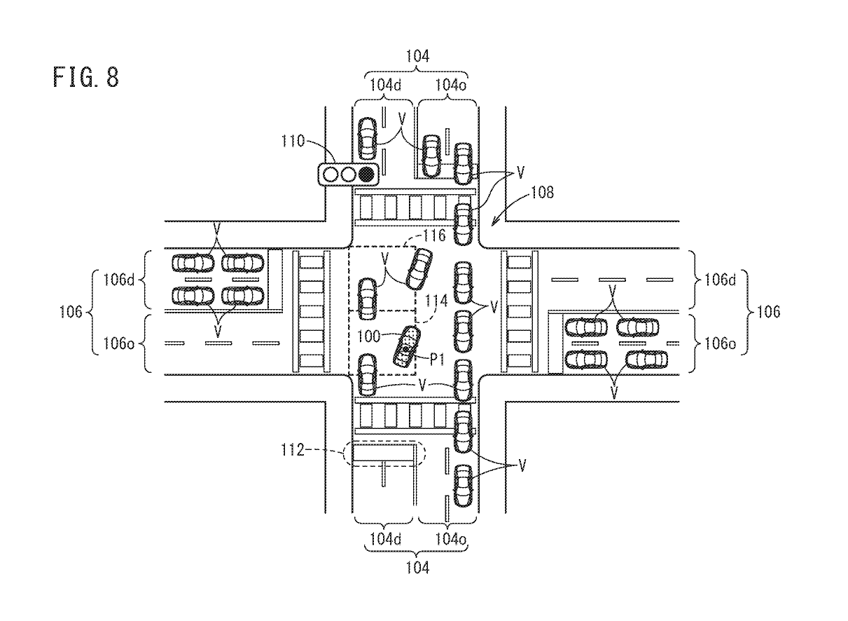

The possibility determining unit 68 evaluates the possibility of being left remaining within the intersection, for example, from a magnitude relationship between a remaining time (t1-t3) of green illumination, and a summation of the three times (Ta+Tw+Tt). The entry time Ta is the time required to travel from the current host vehicle position to the position (the stop position P1 shown in FIG. 8) within the intersection 108. The waiting time Tw is a waiting time from the arrival at the stop position P1 until it becomes possible to make a right turn. The turning time Tt is the time required from the start of making the right turn until the lane movement is completed.

For example, [1] the entry time Ta varies depending on the distance between the host vehicle 100 and the intersection 108, [2] the waiting time Tw varies depending on the traffic flow of the first oncoming lane 104o, [3] the turning time Tt is calculated using an estimation model of time, which is assumed to change depending on the shape (particularly the size) of the intersection 108.

When implemented as described above, in the case that the flow of traffic in the first oncoming lane 104o is small, the waiting time Tw decreases, and therefore, the time margin Tm1 increases. In addition, in the case that the flow of traffic in the first oncoming lane 104o is intermediate (of a medium degree), the margin time Tm2 decreases according to the amount by which the waiting time Tw increases. On the other hand, in the case that the flow of traffic in the first oncoming lane 104o is large, the summation of the times significantly exceeds the remaining time (t1-t3) of the green illumination, and the margin time Tm3 is reduced to zero (none).

In step S6, on the basis of the evaluation result of step S5, the possibility determining unit 68 evaluates the possibility of the host vehicle 100 being left remaining within the intersection 108. For example, in the case that the margin times Tm1 to Tm3 are greater than a threshold value (for example, 5 seconds), the possibility determining unit 68 determines that “the possibility is low”, whereas in all other cases, the possibility determining unit 68 determines that “the possibility is high”.

In this instance, margin times Tm1 to Tm3 are used as index values indicating the likelihood of being left remaining within the intersection, however, the determination may be made based on quantification (scoring) by another method. Alternatively, instead of such a quantification, the determination may be made based on whether or not one or more conditions related to the possibility are met.

In this manner, using the traffic signal information in relation to the illumination time of the traffic signal 110 installed at the intersection 108, the possibility determining unit 68 may make a determination concerning the possibility by evaluating a time concerned with right or left turning of the host vehicle 100. By acquiring the traffic signal information, it becomes possible to quantitatively evaluate the possible remaining time after entering into the intersection 108, and by such an amount, the accuracy in determining the possibility can be improved.

Further, using the traffic flow information in relation to the flow of traffic in the first oncoming lane 104o, the possibility determining unit 68 may make a determination concerning the possibility by evaluating a time concerned with right or left turning of the host vehicle 100. By further acquiring the traffic flow information, it becomes possible to quantitatively evaluate the time required when crossing over the first oncoming lane 104o, and by such an amount, the accuracy in determining the possibility can be improved.

Incidentally, if it is determined that the possibility of being left remaining is low (step S6: YES), the process proceeds to step S7. On the other hand, if it is determined that the possibility of being left remaining is high (step S6: NO), the process proceeds to step S8.

In step S7, the intersection countermeasure unit 56 contends with the host vehicle 100 making a right turn at the intersection 108, after having entered into the intersection 108. More specifically, the intersection countermeasure unit 56 notifies the action plan creation unit 54 that a change in the action plan is unnecessary. The trajectory generating unit 58 generates a travel trajectory for the purpose of changing lanes from the first travel lane 104d to the second travel lane 106d, in accordance with the initial action plan created by the action plan creation unit 54. Consequently, in accordance with the travel trajectory, the travel control unit 60 performs a travel control in order to cause the host vehicle 100 to make a right turn at the intersection 108.

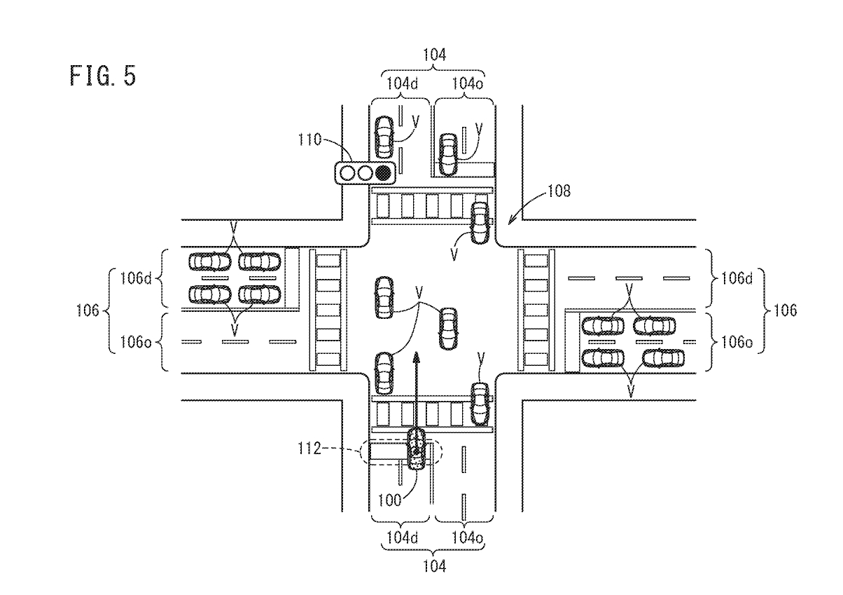

As shown in FIG. 5, the host vehicle 100 passes directly through a stop line 112 of the first travel lane 104d, and enters into the intersection 108 while decreasing the vehicle speed with a constant deceleration.

On the other hand, in step S8, the intersection countermeasure unit 56 carries out a countermeasure to cause the host vehicle 100 to stop without entering into the intersection 108. More specifically, the intersection countermeasure unit 56 notifies the action plan creation unit 54 that a temporary stop is required. The trajectory generating unit 58 generates a travel trajectory for temporarily stopping short of the intersection 108, in accordance with the action plan that was changed by the action plan creation unit 54. Consequently, in accordance with the travel trajectory, the travel control unit 60 performs a travel control to decelerate and stop the vehicle in front of the intersection 108.

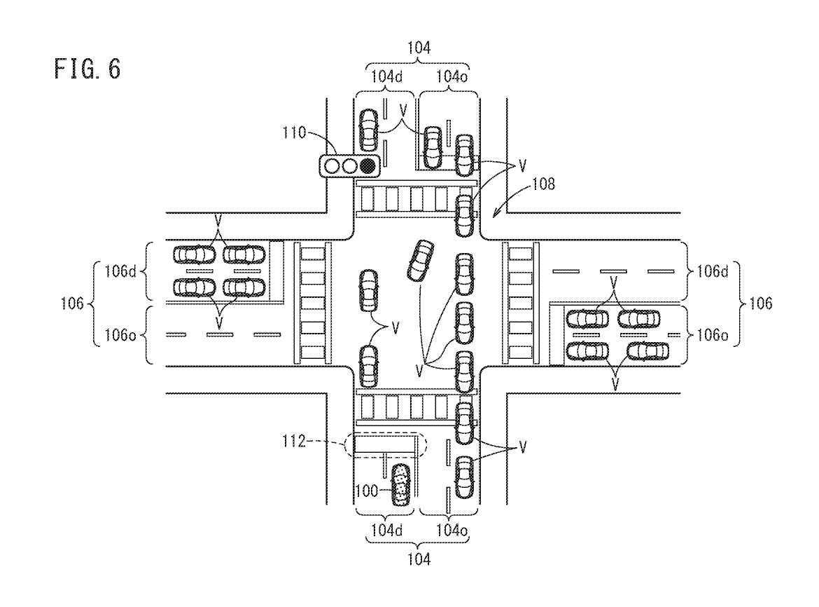

As shown in FIG. 6, the host vehicle 100 stops just before the intersection 108 (more specifically, at the position of the stop line 112) while the vehicle speed is lowered with a greater deceleration in comparison with the case of FIG. 5.

Next, in step S9, the intersection countermeasure unit 56 carries out a countermeasure so that a takeover is effected from automated driving to manual driving. In greater detail, in response to a command from the intersection countermeasure unit 56, the driving control unit 70 (and more specifically, the takeover control unit 62) performs a request control for issuing a request with respect to the driver to take over the responsibility for manual driving.

Upon doing so, responsive to the notification command from the takeover control unit 62, the notification device 34 issues a notification to the effect that the driver should take over the responsibility for driving. The series of operations from the request control to the notification operation is referred to as a “TOR” (takeover request).

In addition, in the case of having accepted a takeover operation by the driver, the vehicle control device 10 switches from the automated driving mode to the manual driving mode (step S9). Thereafter, using the operating devices 24, the driver performs manual driving in order to make a right turn at the intersection 108.

In this manner, when making the determination during a period in which the host vehicle 100 has not yet reached the intersection 108, (a) in the case it is determined that the possibility is relatively low, the driving control unit 70 may cause the host vehicle 100 to enter into the intersection 108, whereas (b) in the case it is determined that the possibility is relatively high, the driving control unit 70 may perform a travel control to cause the host vehicle 100 to stop in front of the intersection 108.

Further, in the case it is determined that the possibility is relatively high, the driving control unit 70 may perform a request control to issue a request with respect to the driver of the host vehicle 100 to take over responsibility for manual driving, while the host vehicle 100 is being decelerated, or is in a state in which the host vehicle 100 is stopped. In accordance with this feature, prior to making a right or left turn at the intersection 108, the responsibility for driving can smoothly be handed over to the driver.

### <Details of Right Turn Countermeasure>

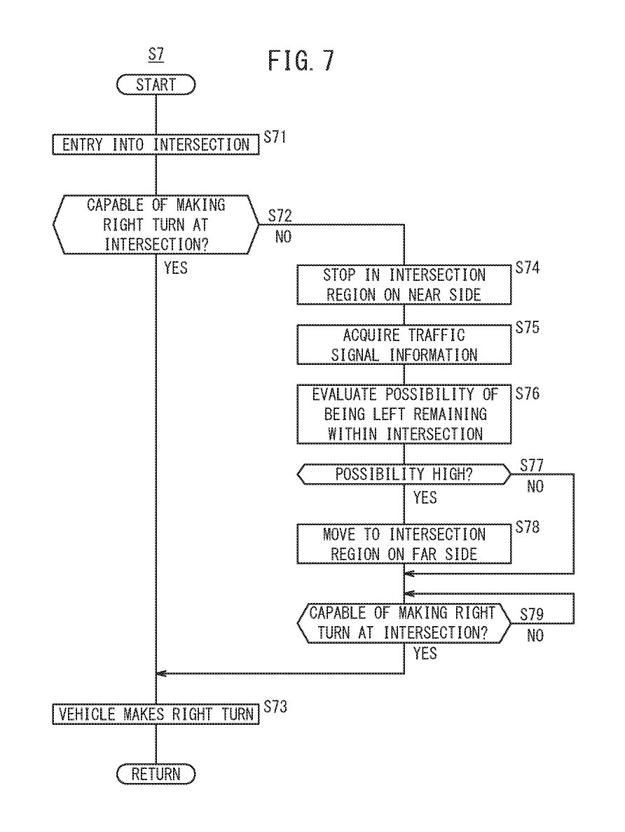

Next, making of a right turn by the host vehicle 100 on the premise of continuing with automated driving (step S7 of FIG. 2) will be described in detail with reference to the flowchart of FIG. 7.

In step S71 of FIG. 7, the driving control unit 70 performs a travel control in order to cause the host vehicle 100 to enter into the intersection 108 along the direction of the solid arrow shown in FIG. 5.

In step S72, the control system 12 determines whether the host vehicle 100 is capable of making a right turn at the intersection 108. More specifically, in the case it is possible to detect an entry space in the first oncoming lane 104o within a predetermined time period from the time at which the host vehicle 100 started to enter into the intersection, the control system 12 determines that “making a right turn is possible”, and in the case that such an entry space cannot be detected, determines that “making a right turn is not possible”. The “entry space” implies a space that is located at a position which is accessible by the host vehicle 100, and that is sufficiently secured to such an extent to allow the host vehicle 100 to cross over the first oncoming lane 104o. If it is determined that making a right turn is possible (step S72: YES), the process proceeds to step S73.

In step S73, while movement of the host vehicle 100 continues, the driving control unit 70 performs a travel control in order to cause the host vehicle 100 to make a right turn at the intersection 108. Upon doing so, while making the right turn, the host vehicle 100 crosses over the first oncoming lane 104o and moves into the second travel lane 106d. Consequently, the right turn which is made by the host vehicle 100 at the intersection 108 is completed.

On the other hand, returning to step S72, if it is determined that an entry space within the first oncoming lane 104o does not exist and that “making a right turn is not possible” (step S72: NO), the process proceeds to step S74.

In step S74, the driving control unit 70 performs a travel control in order to temporarily stop the host vehicle 100 within the intersection 108.

As shown in FIG. 8, while turning slightly in a clockwise direction, the host vehicle 100 stops at a position (hereinafter referred to as a “stop position P1”) within the intersection region 114 on the near side. In the present drawing, two rectangular intersection regions 114, 116 are shown at positions overlapping with the intersection 108. The intersection region 114 on the near side is an overlapping region between the first travel lane 104d and the second oncoming lane 106o. The intersection region 116 on the far side is an overlapping region between the first travel lane 104d and the second travel lane 106d.

In step S75, the information acquisition unit 66 again acquires the traffic signal information at the current point in time. In this instance, the information acquisition unit 66 acquires the traffic signal information using the same method as or a different method from that in the case of the aforementioned step S4 (FIG. 2). As an example of such a different method, the information acquisition unit 66 may acquire the traffic signal information on the basis of detection results by the external environment sensors 14 (for example, the present state of the traffic signal 110 or the present state of a non-illustrated pedestrian traffic signal).

In step S76, using the traffic signal information acquired in step S75, the possibility determining unit 68 evaluates the possibility of the host vehicle 100 being left remaining within the intersection 108. It should be noted that such a computational process is performed during a period in which the host vehicle 100 is present within the intersection 108 (in this instance, the vehicle is stopped in the intersection 108).

In step S77, on the basis of the evaluation result of step S76, the possibility determining unit 68 determines whether or not the possibility is high that the host vehicle 100 will be left remaining within the intersection 108. In this instance, the possibility determining unit 68 may make such a determination using the same or different determination criteria as used in the case of the aforementioned step S6 (FIG. 2).

If it is determined that there is a high possibility that the host vehicle 100 will be left remaining (step S77: YES), the process proceeds to step S78. On the other hand, if it is determined that such a possibility is low (step S77: NO), step S78 is skipped over.

In step S78, the driving control unit 70 performs a travel control in order to cause the host vehicle 100, which is stopped in the intersection region 114 on the near side, to move into the intersection region 116 on the far side.

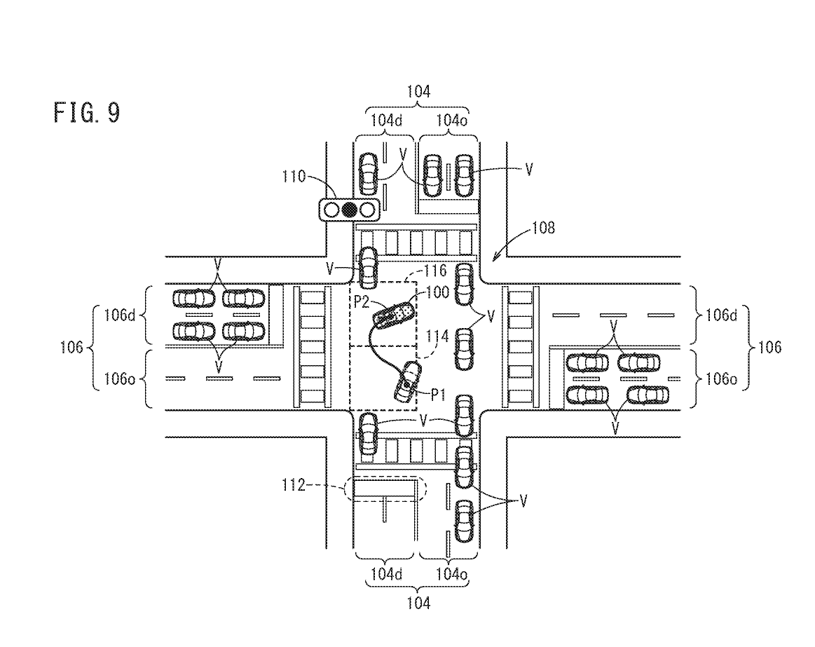

As shown in FIG. 9, the host vehicle 100 travels in the direction indicated by the solid line arrow, while turning widely in a counterclockwise and then a clockwise direction, and thereafter, the host vehicle 100 stops at a position (hereinafter referred to as a “stop position P2”) in the intersection region 116 on the far side.

In step S79, the control system 12 determines whether the host vehicle 100 can make a right turn at the intersection 108, using the same determination method as in the case of step S72. If it is determined that “making a right turn is not possible” (step S79: NO), the process remains at step S79 until it becomes possible to make a right turn. On the other hand, if it is determined that “making a right turn is possible” (step S79: YES), the process proceeds to step S73.

In step S73, while starting movement of the host vehicle 100, the driving control unit 70 performs a travel control in order to cause the host vehicle 100 to make a right turn at the intersection 108. Upon doing so, while generally traveling straight ahead, the host vehicle 100 crosses over the first oncoming lane 104o and moves into the second travel lane 106d. Consequently, the right turn which is made by the host vehicle 100 at the intersection 108 is completed.

In this manner, if determination is made within a period in which the host vehicle 100 resides within the intersection 108, (a) then in the case it is determined that the possibility of being left remaining is relatively low, the driving control unit 70 may continue to stop the host vehicle 100, whereas (b) in the case it is determined that the possibility is relatively high, the driving control unit 70 may perform a travel control to cause the host vehicle 100 to move to within the intersection region 116 of the first travel lane 104d with the second travel lane 106d.

By causing the host vehicle 100 to move into the second travel lane 106d, the crossing distance of the first oncoming lane 104o becomes shorter, and by such an amount, the time required for making the right or left turn is shortened. Also, by causing the host vehicle 100 to evacuate from the second oncoming lane 106o in advance, the flow of traffic from the second oncoming lane 106o immediately after a change in the currently displayed state of the traffic signal 110 is not obstructed.

### [Effects of the Vehicle Control Device 10]

As described above, the vehicle control device 10 is a device which is adapted to control traveling of the host vehicle 100 at least partially automatically, and is equipped with [1] the intersection detection unit 64 which detects the intersection 108 that is on the planned travel route 102 of the host vehicle 100, and in which it is intended to turn to the right or left from the first travel lane 104d across the first oncoming lane 104o, and [2] the driving control unit 70 which performs the travel control automatically, so as to avoid a situation in which the host vehicle 100 is left remaining within the detected intersection 108.

Further, in a vehicle control method using the vehicle control device 10, one or a plurality of computers (ECUs) execute [1] a detection step (step S2) of detecting the intersection 108 that is on the planned travel route 102 of the host vehicle 100, and in which it is intended to turn to the right or left from the first travel lane 104d across the first oncoming lane 104o, and [2] a control step (step S8, step S78) of performing the travel control automatically, so as to avoid a situation in which the host vehicle 100 is left remaining within the detected intersection 108.

Since such a configuration is provided, under the automated travel control, the host vehicle 100 is capable of turning to the right or left at the intersection 108 as quickly as possible, while taking into consideration situations in which the host vehicle 100 may be left remaining within the intersection 108 through which the vehicle intends to pass. Consequently, driving convenience in the case of turning to the right or left at the intersection 108 is enhanced.

In addition, the above-described vehicle control device 10 may further comprise [3] the possibility determining unit 68 which makes a determination concerning the possibility for the host vehicle 100 to be left remaining within the intersection 108, wherein, [4] in the case it is determined that the possibility is relatively high (step S6: NO, step S77: YES), the driving control unit 70 may perform a travel control that differs from a case in which it is determined that the possibility is relatively low (step S6: YES, step S77: NO). In accordance with this feature, suitable driving is performed corresponding to the possibility of being left remaining within the intersection 108.

### [Remarks]

The present invention is not limited to the embodiment described above, and it goes without saying that the present invention can be freely modified within a range that does not depart from the scope of the present invention. Alternatively, the respective configurations may be combined arbitrarily within a range in which no technical inconsistencies occur.

For example, in the present embodiment, in step S74 (FIG. 7), a travel control is performed that causes the host vehicle 100 to stop temporarily at the stop position P1 within the intersection region 114. However, the present invention is not limited to such a control mode. More specifically, depending on traffic conditions, the travel control unit 60 may perform a travel control to cause the host vehicle 100 to stop at the stop position P2 after having been made to move directly into the intersection region 116.

Further, in the present embodiment, although a description was given of a case in which the steering angle of the steering wheel is changed, the control target (angle relating to the steering operation) may be a different physical quantity or a controlled quantity related to steering of the host vehicle 100. For example, such an angle may be a turning angle or a toe angle of the vehicle wheels, or may be a steering angle command value defined inside the vehicle control device 10.

Further, in the present embodiment, although a configuration is adopted in which automated steering of the steering wheel is performed, the means by which the steering angle is changed is not limited to this feature. For example, the travel control unit 60 may output a steer-by-wire command signal to the steering device 30, and thereby change the angle relating to the steering operation as a turning angle of the vehicle wheels. Alternatively, the angle relating to the steering operation as a turning angle of the vehicle wheels may be changed by providing a torque difference (speed difference) between the inner wheels and the outer wheels.

The present invention is also applicable to a case in which a vehicle travels on the right side of the road.

What is claimed is:

1. A vehicle control device configured to control traveling of a host vehicle at least partially automatically, comprising:
an intersection detection unit configured to detect an intersection that is on a planned travel route of the host vehicle, and in which it is intended to turn to right or left from a first travel lane across a first oncoming lane opposed to the first travel lane; and
a driving control unit configured to perform a travel control automatically, so as to avoid a situation in which the host vehicle is left remaining within the intersection that is detected by the intersection detection unit.

2. The vehicle control device according to claim 1, further comprising:
a possibility determining unit configured to make a determination concerning a possibility for the host vehicle to be left remaining within the intersection;
wherein, in a case it is determined by the possibility determining unit that the possibility is relatively high, the driving control unit performs a travel control that differs from a case in which it is determined that the possibility is relatively low.

3. The vehicle control device according to claim 2, further comprising:
an information acquisition unit configured to acquire traffic signal information in relation to an illumination time of a traffic signal installed at the intersection;
wherein, using the traffic signal information acquired by the information acquisition unit, the possibility determining unit makes the determination concerning the possibility by evaluating a time concerned with right or left turning of the host vehicle.

4. The vehicle control device according to claim 3, wherein:
the information acquisition unit further acquires traffic flow information in relation to a flow of traffic in the first oncoming lane;
wherein, further using the traffic flow information acquired by the information acquisition unit, the possibility determining unit makes the determination concerning the possibility by evaluating a time concerned with right or left turning of the host vehicle.

5. The vehicle control device according to claim 2, wherein:
the possibility determining unit makes the determination concerning the possibility during a period in which the host vehicle has not yet reached the intersection; and
in the case it is determined that the possibility is relatively low, the driving control unit performs a travel control to cause the host vehicle to enter into the intersection, whereas in the case it is determined that the possibility is relatively high, the driving control unit performs a travel control to cause the host vehicle to stop in front of the intersection.

6. The vehicle control device according to claim 5, wherein, in the case it is determined that the possibility is relatively high, the driving control unit performs a request control to issue a request with respect to a driver of the host vehicle to take over responsibility for manual driving, while the host vehicle is being decelerated, or is in a state in which the host vehicle is stopped.

7. The vehicle control device according to claim 2, wherein:
in a case that the host vehicle makes a right or left turn at the intersection by moving from the first travel lane into a second travel lane that intersects with the first travel lane, while crossing over the first oncoming lane,
the possibility determining unit makes the determination concerning the possibility during a period in which the host vehicle exists in an intersection region of the first travel lane with a second oncoming lane opposed to the second travel lane.

8. The vehicle control device according to claim 7, wherein, in the case it is determined that the possibility is relatively low, the driving control unit performs a travel control to continue to stop the host vehicle, whereas in the case it is determined that the possibility is relatively high, the driving control unit performs a travel control to cause the host vehicle to move to within an intersection region of the first travel lane with the second travel lane.
